(19) United States
(12) Patent Application Publication
(10) Pub. No.: US 2004/0037366 A1
(43) Pub. Date: Feb. 26, 2004

(54) Apparatus and method for multicarrier modulation and demodulation

(75) Inventor: James A. Crawford, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Magis Networks, Inc., San Diego, CA (US)

(21) Appl. No.: 10/226,392

(22) Filed: Aug. 23, 2002

(51) Int. Cl. H04L 27/04

(52) U.S. Cl. 375/295

(57) ABSTRACT

The present invention provides a method and apparatus for signal processing for signal modulation and demodulation. In signal processing the present invention maintains substantially identical gain and group delays between transmit in-phase (I) and transmit quadrature-phase (Q) paths by receiving a digital transmit I baseband signal and a digital transmit Q baseband signal of a first multicarrier communication signal. A digital transmit IF signal is digitally constructed from the transmit I and Q digital baseband signals including bandpass sampling and the digital transmit IF signal is converted to an analog transmit IF signal. The present invention additionally maintains substantially identical gain and group delays between receive I and Q paths.

### BACKGROUND

1. Field of the Invention

The present invention relates generally to intermediate frequency (IF) modulation and demodulation, and more specifically to the use of bandpass sampling techniques for precision modulation and demodulation of multicarrier modulation schemes.

2. Discussion of the Related Art

Traditionally, the most prevalent digital modulation waveforms (e.g., MSK, GMSK, π/4-DQPSK, QAM) that utilize a single modulated carrier have been synthesized using baseband signaling techniques that separate the modulation into in-phase (I) and quadrature-phase (Q) components. Traditional communication signal processing methods make use of the I and Q signal representation because it is mathematically straight-forward while being closely aligned to the most common modulation methods being employed. The I, Q rectangular signal representation is capable of representing any signal of interest.

In the case of a single modulated carrier signal, separation between the I and Q components of the modulation is directly related to the amplitude and phase balance of the techniques employed. FIG. 1 illustrates a conventional transmitter 18 that uses a traditional baseband I, Q approach to single carrier signal modulation at intermediate frequency (IF) and/or radio frequency (RF). A baseband digital signal 10 is initially processed through a digital signal processor 12, such as mapping into in-phase (I) and quadrature-phase (Q) signals, and other signal processing. Mapping into I- and Q-signals allows for simplified signal modulation. The digital baseband I- and Q-signals are then converted through an analog-to-digital converter 14 to analog I and Q signals. Analog lowpass anti-aliasing filters 16a and 16b are required in each of the I and Q paths, respectively, to attenuate the digital images that are present at the D/A converter outputs. These analog filters introduce additional imbalances between the I and Q signals. Modulation of the analog I- and Q-single carriers normally involves impressing the I and Q modulation upon in-phase and quadrature-phase local oscillators and summing the components to create a resultant modulated carrier. In the context of FIG. 1, the mixers 20a-b, phase-splitter 22 and summer 24 are all IF analog components, which have their own imperfections associated with them. Similar imbalances and imperfections also result in receivers performing demodulation of received signals.

Orthogonal Frequency Division Multiplexing (OFDM) signaling is an increasingly popular modulation technique being used for wireless networks where signal multipath is of concern. OFDM is a modulation method that encodes multiple data symbols concurrently onto multiple radio frequencies, or “tones,” rather than encoding data symbols onto just one radio frequency as with conventional single carrier transmission schemes. In other words, OFDM uses multiple carriers. This multicarrier scheme results in very efficient use of bandwidth and provides robust communications in the presence of noise, intentional or unintentional interference, and reflected signals that degrade radio communications.

OFDM technology breaks one high-speed data signal into tens or hundreds of lower speed signals, which are all transmitted in parallel. The data is divided across the available channel spectrum into a set of tones. Each tone is mathematically orthogonal to all of the other tones.

Because OFDM is made up of many narrowband tones, frequency selective fading (as a result of multipath propagation) degrades only a small portion of the signal and has little or no effect on the remainder of the frequency components. This makes the OFDM system highly tolerant to multipath propagation and narrowband interference. Nevertheless, such frequency-selective fading can be severe to the affected portion of the signal and can affect the OFDM sub-channels differently across the RF bandwidth involved.

It is with respect to these and other background information factors that the present invention has evolved.

### SUMMARY OF THE INVENTION

The present invention advantageously addresses the needs above as well as other needs through a method and apparatus for signal processing for signal modulation and demodulation. In one embodiment, the method includes the steps of maintaining substantially identical gain and group delays between transmit in-phase (I) and transmit quadrature-phase (Q) paths, comprising: receiving a transmit I digital baseband signal and a transmit Q digital baseband signal of a first multicarrier communication signal; digitally constructing a digital transmit IF signal from the transmit I and Q digital baseband signals including bandpass sampling; and converting the digital transmit IF signal to an analog transmit IF signal.

The present invention provides a method for multicarrier signal conditioning for communication including the steps of receiving an analog receive intermediate frequency (IF) signal of a first multicarrier communication signal; converting the analog receive IF signal to a digital receive IF signal; commutating the digital receive IF signal producing a digital receive I bandpass signal and a digital receive Q bandpass signals; interpolating the digital receive Q bandpass signal; interpolating the digital receive I bandpass signal; and generating digital receive I baseband signal and a digital receive Q baseband signal.

In one embodiment, the method includes the steps of: receiving an in-phase (I) digital baseband signal and a quadrature-phase (Q) digital baseband signal of a multicarrier communication signal; digitally constructing a digital IF signal from the I and Q digital baseband signals; and converting the digital IF signal to an analog IF signal.

In one embodiment, the method for down converting from an IF signal includes the steps of: receiving a multicarrier analog IF signal of a multicarrier communication signal; converting the analog IF signal to a digital IF signal; and digitally decomposing the digital IF signal into an in-phase (I) digital baseband signal and a quadrature-phase (Q) digital baseband signal.

In one embodiment, the present invention provides an apparatus for multicarrier signal processing having a first interpolator coupled to receive digital bandpass in-phase (I) signal of a multicarrier signal, and configured to adjust a delay of digital bandpass I signal; a second interpolator coupled to receive digital bandpass quadrature-phase (Q) signal of a multicarrier signal, and configured to adjust a delay of digital bandpass Q signal; a transmit signal construction unit coupled with the first and second interpolators, and configured to construct a digital IF transmit signal from the adjusted digital bandpass I and Q signals; and a digital-to-analog converter coupled with the transmit signal construction unit to receive the digital IF transmit signal, and configured to convert the digital IF transmit signal to an analog IF transmit signal.

The present invention further provides for an apparatus for multicarrier signal processing. The apparatus includes a analog-to-digital converter configured to receive an analog IF receive signal of a multicarrier signal and to convert the analog IF receive signal to a digital IF receive signal; a receive signal decomposition unit coupled with the analog-to-digital converter, and configured to decompose the digital IF receive signal into a digital IF in-phase (I) receive signal and digital IF quadrature-phase (Q) receive signal; a first interpolator coupled with the decomposition unit to receive the digital I receive signal, and configured to adjust a delay of digital I receive signal producing digital bandpass I receive signal; and a second interpolator coupled with the decomposition unit to receive the digital Q receive signal, and configured to adjust a delay of digital Q receive signal producing digital bandpass Q receive signal.

In one embodiment, a system for providing multicarrier signal processing includes: a first interpolator configured to receive digital baseband in-phase (I) signal of a multicarrier signal and to up-sample the digital baseband I signal to an intermediate frequency (IF) digital I signal; a second interpolator configured to receive digital baseband quadrature-phase (Q) signal of the multicarrier signal and to up-sample the digital baseband Q signal to an IF digital Q signal; a transmit signal construction unit coupled with the first and second interpolators, and configured to construct a digital IF transmit signal from sampled the IF digital I and Q signals; and a digital-to-analog converter coupled with the transmit signal construction unit to receive the digital IF transmit signal, and configured to convert the digital IF transmit signal to an analog IF transmit signal.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified block diagram of a previous baseband I,Q approach to single carrier signal modulation;

FIG. 2 depicts a graphical representation of an evaluation of Equation (1);

FIG. 3 depicts a graphical representation of positive and negative frequency sideband components around the baseband center frequency;

FIG. 4 depicts a graphical representation of an example of a group delay variation resulting from a previous baseband system with a 10 MHz passband width;

FIG. 5 depicts a graphical representation of an example of a group delay variation resulting from a previous baseband system with a 15 MHz passband width;

FIG. 6 depict a simplified block diagram of one implementation of an apparatus for constructing signals for multicarrier signal processing according to one embodiment of the present invention;

FIG. 7 depicts one embodiment of a simplified block diagram of a transmit signal construction unit that can be incorporated into the apparatus of FIG. 6;

FIG. 8 depict a simplified block diagram of one implementation of an apparatus for receive signal decomposition for multicarrier signal processing according to one embodiment of the present invention;

FIG. 9 depicts a simplified block diagram of a receive signal decomposition unit that can be implemented in the apparatus of FIG. 8;

FIG. 10 depicts a simplified block diagram of an FIR-based sample interpolator according to one embodiment of the present invention;

FIG. 11 shows a plurality of different delay-line scenarios (A)-(F) for delay line shift registers;

FIG. 12 depicts a simplified block diagram showing a relationship between RF frequency errors and sample-rate frequency errors; and

FIG. 13 depicts a simplified schematic diagram of one implementation of a component for determining the sample rate error.

Corresponding reference characters indicate corresponding components throughout the several views of the drawings.

### DETAILED DESCRIPTION

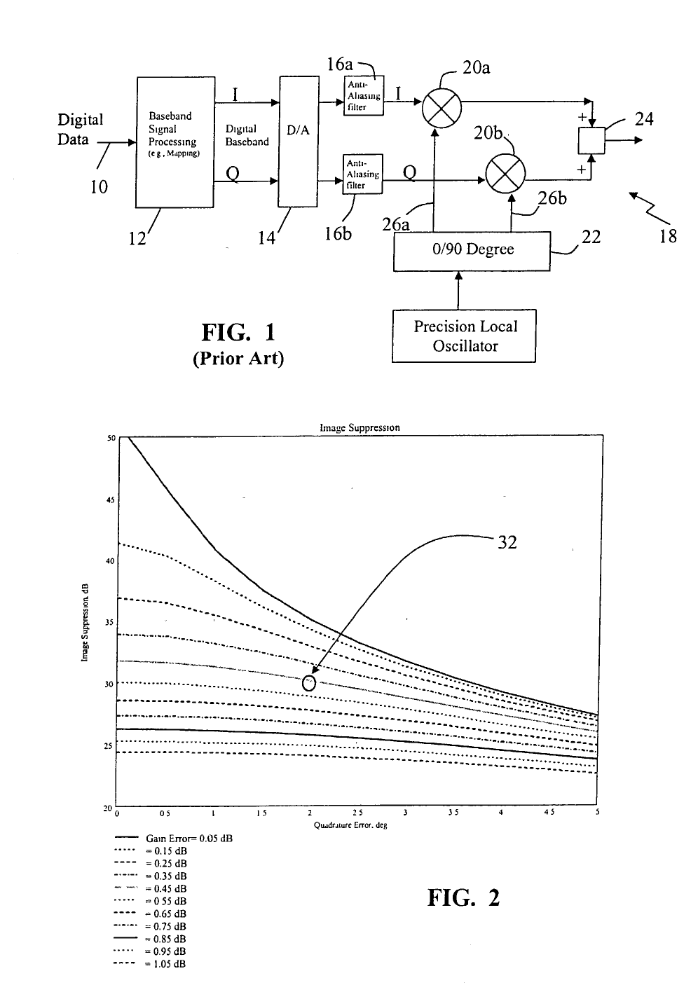

As discussed above, many conventional single carrier modulation systems operate at baseband frequencies and perform signal processing for modulation and demodulation on signals in the analog domain. While such techniques may provide adequate modulation and demodulation for single carrier modulation schemes, it has been found herein that the use of conventional baseband signaling techniques that separate the modulation into in-phase (I) and quadrature-phase (Q) components through analog electronics is prone to very difficult balance issues if applied to multicarrier modulation schemes, such as for example Orthogonal Frequency Division Multiplexing (OFDM). Moreover, such techniques require extremely complex systems to maintain gain and delay balancing of the I and Q signals for multicarrier modulation schemes. These balance issues will first be illustrated in the below discussion by examining the traditional baseband I, Q approach illustrated in FIG. 1 for the single modulated carrier scenario.

As mentioned above, the mixers 20a-b, phase-splitter 22 and summer 24 are all IF-analog components which have their own imperfections associated with them. Simple trigonometry can be employed to show that the suppression of the unwanted modulation sideband in the case of a sinusoid applied at baseband is given by:

$$L = 10 {Log}_{10} [ \frac{{ρ}^{2} + 2 ρ cos ( θ ) + 1}{{ρ}^{2} - 2 ρcos ( θ ) + 1} ] \qquad ( 1 )$$

where θ is the phase error (relative to a perfect 90 degree phase split) between the in-phase and quadrature local oscillator signals, and ρ=10^{0.05 ΔG} where ΔG is the gain difference between the I- and Q-channel paths in dB.

FIG. 2 illustrates an evaluation of Equation (1), namely, single sideband suppression versus phase and amplitude error. As shown, fairly good phase and amplitude control must be delivered in order to have good suppression of the unwanted modulation sideband. For example, in order to have 30 dB suppression, a representative performance level is a maximum phase error of 2 degrees and an amplitude error of at most 0.45 dB.

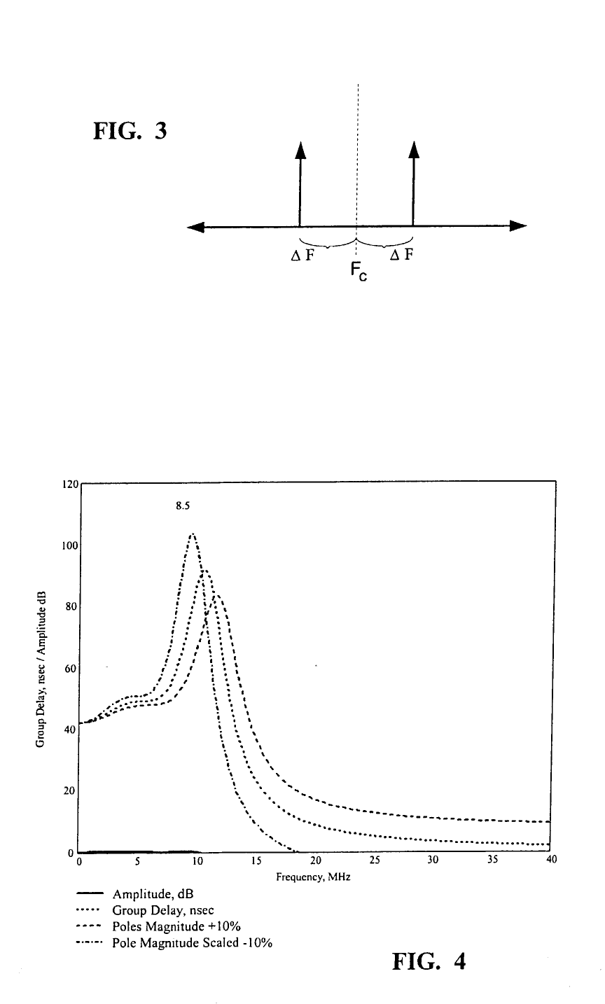

One of the underlying problems with previous baseband I, Q approaches is that positive-frequency and negative-frequency sideband components both occupy the same physical frequency at baseband. FIG. 3 depicts a graphical representation of positive and negative frequency sideband components, −ΔF and +ΔF, respectively, around the baseband center frequency F_{c}, where the center frequency is on the order of zero Hertz. Because both the positive and negative sidebands occupy virtually the same physical frequency sidebands (|−ΔF|≈|+ΔF|), previous systems must rely completely on precise quadrature and amplitude balancing to keep cross-frequency terms adequately suppressed.

In previous systems, the I and Q baseband components, as shown in FIG. 1, are digitally created using digital-to-analog (D/A) devices followed by analog anti-aliasing filters. Group delay and amplitude balance in the baseband filtering are crucial if upper-sideband and lower-sideband components are to remain separate.

It has been found herein that group delay and amplitude balance in the baseband filtering are even more crucial in the context of OFDM, especially for signal constellations such as 64-QAM. For example, the IEEE 802.11a standard for wireless local-area networking (WLAN) uses OFDM. The maximum OFDM subcarrier frequency offset for the standard 802.11a mode is approximately 8.5 MHz. In 64-QAM operation, extremely precise control of phase and amplitude is required. If the I and Q baseband signals for a single OFDM frequency subcarrier bin n are given by:

I(t)=cos(2πΔFnt+θ)

Q(t)=A sin[2πΔFn(t+τ)+θ] (2)

where A represents the non-unity amplitude error and τ represents the group delay imbalance between I and Q channels for the n^{th} bin, then the Q-channel related interference that falls on the I-channel is at a level of 20 Log[A sin(2πnΔFτ)] dB. In other words, the resultant baseband I and Q channel signals with these impairments present for the n^{th} subcarrier bin are given by:

Iᵣₓ_{_{—}}ₙ(t)=[Iₙ(t)+AQₙ(t)sin(2πΔFnτ)]cos(2πΔFnt+θₙ)

Qᵣₓ_{_{—}}ₙ(t)=AQₙ(t)cos(2πΔFNτ)sin(2πΔFnt+θₙ) (3)

For 64-QAM in the IEEE 802.11a context, sensitivity (10⁻⁴ coded bit error rate) corresponds to a bin-by-bin carrier-to-noise-ratio (CNR) of approximately 20 dB. In order to have a reasonably small system loss on an additive-white-Gaussian-noise (AWGN) channel, it is desirable to have a minimum carrier-to-interference-ratio (CIR) of approximately 25 dB. Disregarding amplitude errors between the I and Q channels, this translates to a maximum allowable group delay imbalance for the ±26^{th} OFDM subcarriers of 1.1 nsec pursuant to Equation (3) for the Iᵣₓ_{_{—}}ₙ component, which is extremely small. The group delay matching between I and Q baseband filter paths is less stringent for decreasing OFDM bin index n, but this example clearly illustrates the bin-by-bin group delay balance that must be delivered by the I and Q baseband filter paths.

It is extremely difficult to match the analog low pass filters for group delay and provide balanced amplitude between the I and Q signals. Due to the inability to adequately match the low pass filters, previous systems required complex gain and phase imbalance adjustment circuitry. This adds significant additional design complexity to the system, which increases costs.

For single-carrier systems, the net receiver performance loss due to these imbalance issues is governed by the aggregate carrier-to-interference ratio computed across the entire modulation bandwidth. For OFDM however, the balance questions must be considered on a bin-by-bin basis because excessive imbalance for any individual bin directly impairs communication performance on that specific subcarrier. This can be cast in a mathematical fashion by using the same OFDM frequency bins to describe the carrier-to-interference impact for both the single-carrier system as well as the OFDM system.

For example, if the desired carrier power falling in each frequency bin region is denoted by Cₖ and the interference-plus-noise power falling in each frequency bin region is denoted by NIₖ, the theoretical bit-error-rate (BER) performance for the single-carrier system using BPSK (chosen to simplify the example) would be given approximately by:

$${P}_{sc} = \frac{1}{2} erfc ( \sqrt{\frac{{\sum }_{k}^{} {C}_{k}}{{\sum }_{k}^{} {NI}_{k}}} ) \qquad ( 4 )$$

In contrast, the BER performance for the OFDM system utilizing BPSK on each individual subcarrier using the otherwise-same total signal power would be given by:

$${P}_{OFDM} = \frac{1}{2} {\sum }_{k}^{} erfc ( \sqrt{\frac{ {C}_{k}}{ {NI}_{k}}} ) \qquad ( 5 )$$

As clearly illustrated by comparing Equations (4) and (5), the OFDM system is much less tolerant of mismatches across the filter passband in frequency. This makes the baseband filter matching much more critical for OFDM systems than for single-carrier systems using the same underlying modulation type (i.e., BPSK in this example).

In actual system use, the 25 dB CNR mentioned for 64-QAM is inadequate for two primary reasons. First, there is a need for better performance with increased receive signal strength in order to drive the system bit-error-rate to levels lower than 10⁻⁴. Second, there is a need to deliver a better CNR when the receive signal strength is adequate to do so in order to accommodate frequency-selective fading that may be occurring for one sideband at frequency offset +Fₘ and not occurring at the opposite sideband at frequency offset −Fₘ. In order to support, for example, a 10 dB fade-margin and acceptable performance impact, the ultimate CNR should approach a minimum of 35 dB for the 64-QAM case. This translates to a group delay match between baseband I and Q filters of 0.35 nsec, which is even smaller than the 1.1 nsec calculated above.

In addition to the phase and magnitude matching issues that must be addressed in any baseband I, Q system (as illustrated in FIG. 2 for example), the group delay balance problem for OFDM is particularly difficult. Balancing the group delay in OFDM is difficult because matching is dependent upon precise control of the lowpass filter pole locations. And compounding this difficulty is the fact that absolute pole location accuracy is reasonably difficult to achieve in an integrated form, such as in an integrated circuit (IC). The group delay balancing problem is aggravated if the corner frequency of the filter is near the edge of the OFDM modulation bandwidth.

In an all-pole lowpass filter (e.g., Butterworth, Bessel), the filter transfer function can be represented as:

$$H ( s ) = {A}_{0} {\prod }_{n = 1}^{N} \frac{1}{s + ( {σ}_{n} + j {ω}_{n} )} \qquad ( 6 )$$

where Laplace transforms are being used and the poles are represented by the σₙ+jωₙ quantities. The group delay through the filter is given by:

$$\begin{matrix}D ( ω ) = {\sum }_{n = 1}^{N} ( \frac{{σ}_{n}}{{σ}_{n}^{2} + {( ω - {ω}_{n} )}^{2}} ) \\ = {\sum }_{n = 1}^{N} ( \frac{1}{{σ}_{n}} \frac{1}{1 + {( \frac{ω - {ω}_{n}}{{σ}_{n}} )}^{2}} )\end{matrix} \qquad ( 7 )$$

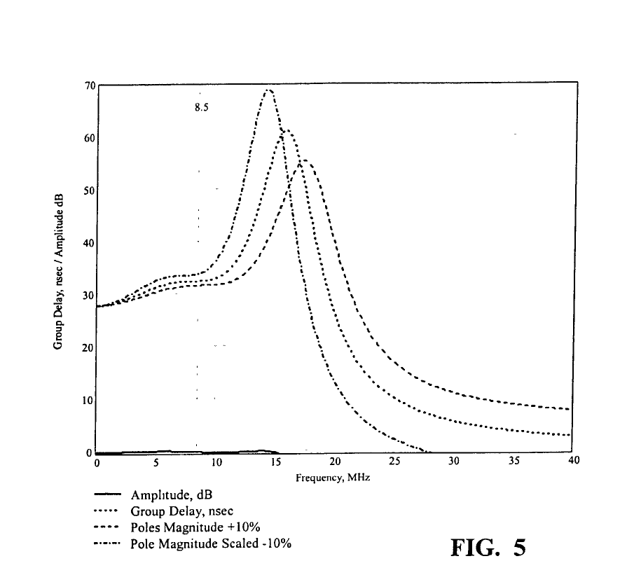

As evidenced by Equation (7), the group delay is most substantially influenced by the high-Q filter poles (i.e., poles with smallest |σ|). Additionally, the further the filter corner frequency is from the modulation bandwidth edge, the smaller the group delay mismatch that occurs for a fixed percentage error in the filter pole locations. Two example group delay evaluations are shown in FIGS. 4 and 5 that exhibit the problem with realizing narrow bandwidth active filters in the presence of pole location inaccuracies.

FIG. 4 depicts a graphical representation of an example of a group delay variation resulting from a previous baseband system for an N=4 Chebyshev, with a 0.25 dB passband ripple and a 10 MHz passband width. It can be seen in FIG. 5 that the group delay variation at the modulation edge severely exceeds allowable limits. FIG. 5 depicts a graphical representation of an example of a group delay variation resulting from a previous baseband system for an N=4 Chebyshev, with a 0.25 dB passband ripple and a 15 MHz passband width. The group delay variation at the modulation edge is improved as compared with the group delay show in FIG. 4. However, the group delay resulting in FIG. 5 is still far above tolerable limits. Additionally, a wide passband results in adjacent channel rejection issues, requiring higher analog to digital (A/D) sampling rate in order to attempt to convert the signal.

As can be seen, the group delay imbalance issues are more difficult in a receiver because adjacent channel filtering issues typically require heavier filtering than in the transmitter. These imbalance issues are extremely difficult to alleviate in a direct-down-conversion receiver because all of the channel selective filtering must be accomplished in the I- and Q-channel analog arm filters.

Therefore, as demonstrated in the above discussion, conventional baseband techniques encounter extremely difficult balancing issues when applied to multicarrier modulation schemes, such as for example OFDM, as well as other multicarrier modulation techniques. Furthermore, balance between the I- and Q-channels is much more critical for multicarrier modulation operating over a multipath channel than for single carrier systems.

The present invention provides for precision modulation and demodulation of multicarrier signals, such as for example OFDM. The present invention overcomes many of the problems associated with baseband signaling techniques for multicarrier modulation by instead utilizing bandpass signal processing. It is believed that the extreme benefits of utilizing bandpass signal processing in multicarrier modulation techniques to avoid imbalances between I and Q baseband analog filters that follow a down-conversion or precede an up-conversion has gone completely unrealized and unutilized. Previous implementations of bandpass sampling have only been used to accommodate a flat frequency error in phase and/or amplitude that results in analog frequency up-conversion or down-conversion, whereas the present invention achieves highly selective analog filtering without incurring imbalances between positive and negative frequency components of the signal involved.

Embodiments of the present invention utilize bandpass sampling techniques for both the transmit signal construction and the receive signal decomposition. Signal processing on the I- and Q-channel signals is performed in the digital domain to substantially eliminate imbalances. Thus, the present invention solves the imbalance problems seen in previous systems (i.e., the gain and phase errors in the RF single-sideband conversion, and the gain and group delay imbalances in the baseband I- and Q-channel arm filters) by avoiding the need to perform analog processing of the I- and Q-channel signals where both positive and negative sideband components occupy the same physical frequency at baseband.

The use of bandpass signal processing for multicarrier modulation techniques in the present invention greatly enhances the signal processing, enhances the circuit designs used in performing the signal processing and modulation, and improves the demodulation and/or decomposition of modulated signals to achieve highly accurate communication. In utilizing bandpass techniques with multicarrier modulation, the present invention substantially eliminates imbalances between the I- and Q-channel baseband filters. Bandpass sampling methods are extremely well suited for use with OFDM waveforms, circumventing virtually all such balance issues. The bandpass sampling preformed through the present invention avoids the OFDM bin-by-bin amplitude and delay imbalances between positive and negative frequency components that result in previous direct-conversion techniques.

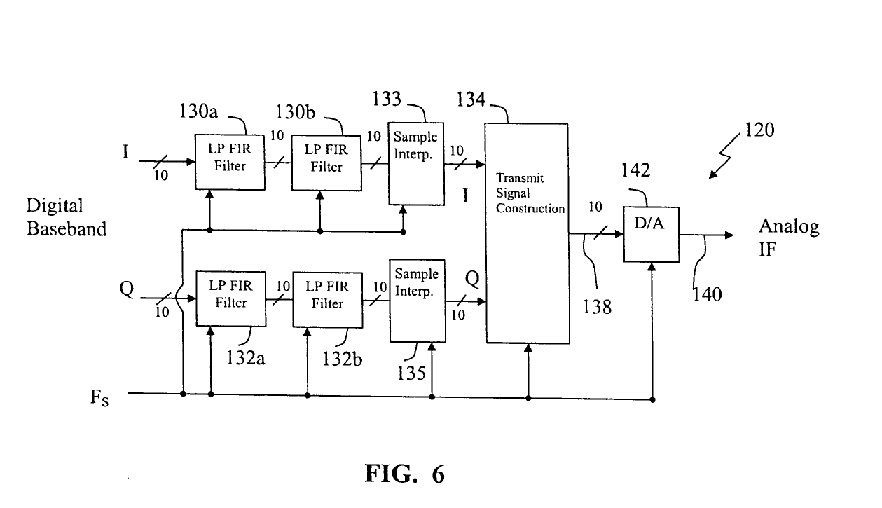

FIG. 6 depicts a simplified block diagram of one implementation of an apparatus 120 for signal processing in signal construction for multicarrier modulation according to one embodiment of the present invention. Similar to previous systems, the present invention performs the signal processing utilizing the I- and Q-form of a signal. However, in contradiction to previous systems, the present invention performs signal processing of both the I- and Q-signals in the digital domain. Processing in the digital domain allows the present invention to employ digital components in both the I- and Q-arms of the apparatus such that there is substantially zero gain difference and substantially zero delay difference between the I- and Q-paths. Each of the I- and Q-arms include one or more digital filters 130a-b and 132a-b, respectively. Because the filters are digital, they can be constructed with substantially identical characteristics avoiding mismatched gains and delays between the I- and Q-arms. Thus, the present invention avoids many of the problems seen with prior art systems by substantially eliminating imbalances in the I- and Q-channel signals.

Additionally, the apparatus 120 uses over-sampling of both the I- and Q-baseband signals to create a composite signal centered at a nonzero bandpass center frequency. In one embodiment, the filters 130a-b, 132a-b remove adjacent channel energy if present, up-sample the digital signals and provide some interpolation of the I- and Q-signals. For example, the filters can be implemented through FIR filters to provide filtering, up-sampling and inter-sample interpolation to fill in at least a portion of the gaps resulting between even and odd samples, as described more fully below. The first stage of filters 130a and 132a can up-sample the I- and Q-signals by a factor of two, and the second stage of filters 130b and 132b can again up-sample the signals by a factor of two (e.g., the I- and Q-signals can be up-sampled from 20 MHz to 40 MHz in the first stage, and from 40 MHz to 80 MHz in the second stage). The digital I- and Q-signals are forwarded to interpolators 133 and 135 to provide I- and Q-digital bandpass signals that are in time-step. For example, the interpolators can be sample interpolators configured to sample the digital signals at the over sampling rate, e.g., a rate of 80 MHz, to produce sampled bandpass I- and Q-signals. In one embodiment, the apparatus 120 generates the bandpass signals centered at an intermediate frequency (IF) to in part simplify filtering. Because the signals are over sampled to produce the bandpass signals, positive and negative sidebands do not have the same physical frequencies. As such the up-sampling and over sampling to an intermediate frequency avoids many of the problems seen in the prior art including avoiding imbalances between the I- and Q-signals.

The sample interpolators additionally help to maintain timing alignment between transmit and receive signals, as well as in delivering consistently flat group delay characteristics between the I- and Q-arms. The sample interpolators 133, 135 provide time base adjustments of the I- and Q-signals. In one embodiment, a digital phase lock loop (DPLL) is coupled with or included within the apparatus 120 to monitor and/or update RF frequency errors operating at, for example 5 GHz. The sample interpolators 133, 135 determine time adjustments needed to compensate for the frequency error. As such, the present apparatus 120 operates off of a single clock reference (as dictated by the IEEE 802.11a specification) while still maintaining the tight control and without requiring the use and adjustment of a voltage controlled crystal oscillator (VCXO). This allows the present invention to utilize the combination of the frequency error and the sample interpolator to deliver substantially perfect coherent processing across individual medium access control (MAC) frames while tolerating noncoherence between MAC frames.

The interpolated I- and Q-signals are forwarded to a transmit signal construction unit 134 that combines the I- and Q-signals producing a digital bandpass transmit signal 138. The sampling rate for the sample interpolator 133, 135 and transmit signal construction unit 134 (and in some embodiments filters 130 and 132) is selected as such to maintain the transmit signal 138 at the bandpass frequency. Following the digital signal processing, the apparatus 120 then converts the bandpass transmit signal 138 to an analog transmit signal 140 through a digital to analog converter (D/A) 142. Thus, the present invention solves the imbalance problems seen in prior art systems by avoiding the performance of analog signal processing of the I- and Q-signals where both the positive and negative sideband components occupy the same physical frequency.

The present invention utilizes bandpass techniques for the transmit signal construction by up-sampling both the I- and Q-signals. As discussed above, the benefits of bandpass sampling for use with multicarrier modulation and demodulation have not previously been realized. The use of bandpass techniques allows the present invention to avoid analog and RF signal processing where positive and negative sidebands occupy the same physical frequency, and additionally simplifies the elimination of unwanted spectrum components and image frequency bands. The present invention additionally utilizes the conversion to bandpass to achieve a simplified and accurate bandpass sampling and thus provide more accurate and simplified signal processing. Over sampling (for example at four times the baseband) allows substantially identical filters to be utilized for the I- and Q-paths allowing the generation of the I- and Q-values at substantially the same time instant without introducing imbalances between the I- and Q-signals.

The present invention spreads the spectrum components and image frequency bands, allowing simplified filtering to be employed to eliminate unwanted analog and RF components. As discussed above, previous systems operating at baseband cannot achieve accurate enough analog filters because of the close proximity of unwanted image frequencies. Spreading the spectrum allows the present invention to employ simple filters. For example, the present invention during signal construction up-samples the baseband I- and Q-channel signals using an 80 MHz sampling rate to create an analog IF signal centered at 60 MHz. Up-sampling spreads the spectrum to allow analog filters to be utilized to filter out unwanted spectrum components, for example unwanted spectrum components at 20 MHz and unwanted image frequency bands at 100 MHz or higher.

In one embodiment, the present invention performs signal processing at a bandpass frequency that is centered at an intermediate frequency (IF). The present invention optimizes the location of adjacent digital image bands relative to a desired passband by utilizing a relationship of:

Fₛ=(4F_{IF}/(2n+1)), (8)

where Fₛ is an adopted sampling rate, F_{IF} is a desired IF frequency, and n is a positive integer.

The sampling rate Fₛ is chosen high enough to satisfy the Nyquist criteria associated with: (a) the modulation bandwidth; and (b) the ability to suppress digital image responses by way of analog filtering. In one embodiment, this filter is achieved through analog/RF filtering placed after a single D/A converter in the construction of a transmit signal, and before a single A/D converter in decomposing a receive signal. In one embodiment, an IF frequency of F_{IF}=60 MHz is selected with n=1 resulting in a sampling frequency of Fₛ=80 MHz. It will be apparent to one skilled in the art that other IF frequencies, n values and sampling frequencies can be utilized without departing from the inventive aspects of the present invention.

The present invention utilizes bandpass sampling in signal construction for a transmit signal. The transmit signal, constructed using digital techniques, can be represented mathematically by:

$$\begin{matrix}s ( t ) = I ( t ) cos ( {ω}_{o} t ) - Q ( t ) sin ( {ω}_{o} t ) \\ {s}_{k} = {I}_{k} cos ( 2 π60 MHz \frac{k}{80 MHz} ) - {Q}_{k} sin ( 2 π60 MHz \frac{k}{80 MHz} ) \\ {s}_{k} = {I}_{k} cos ( 2 π \frac{3}{4} k ) - {Q}_{k} sin ( 2 π \frac{3}{4} k )\end{matrix} \qquad ( 9 )$$

where k represents a sampling index.

A sample frequency Fₛ and intermediate frequency F_{IF} are selected to capitalize on the relationship defined by Equation (9) between the selected IF center frequency and the sampling rate Fₛ. By taking advantage of this relationship, a transmit signal can be generated that alternates with every other sample index to include a sample of the I- signal or the Q-signal. Table 1 illustrates the resulting behavior of Equation (9) for a plurality of sample index values k where Fₛ is selected at 80 MHz with an intermediate frequency F_{IF} of 60 MHz.

TABLE 1
Sample Orchestration During Transmit Signal Construction

| Sample Index k | Sₖ DAC Output |
|---|---|
| 0 | I₀ |
| 1 | Q₁ |
| 2 | −I₂ |
| 3 | −Q₃ |
| 4 | I₄ |
| 5 | Q₅ |
| 6 | −I₆ |
| 7 | −Q₇ |
| 8 | I₈ |
| 9 | Q₉ |
| 10 | −I₁₀ |

Sampling at the 80 MHz sampling rate allows the invention to provide bandpass signal processing centered at 60 MHz to construct and decompose the multicarrier signal. This scheme makes use of the first digital image centered at 60 MHz rather than using the fundamental output that is centered at 20 MHz. Thus, as discussed above, analog bandpass filters can be used (positioned after a D/A converter in transmitting signals, and before an A/D converter in receiving signals) to eliminate unwanted digital spectrum components (e.g., components centered at the 20 MHz and at image frequency bands of 100 MHz and higher).

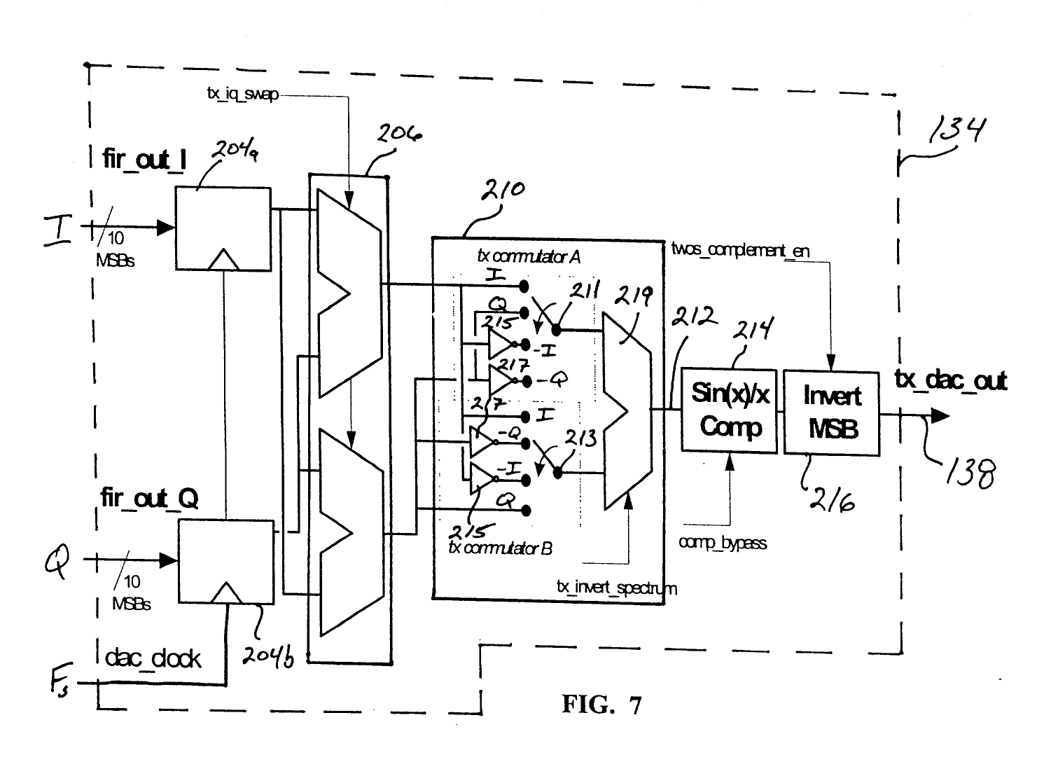

FIG. 7 depicts one embodiment of a simplified block diagram of a trasmit signal construction unit 134 that combines the I- and Q-signals producing a digital bandpass transmit signal 138. The transmit signal construction unit implements the advantageous relationship described by Equation (9) to produce a transmit signal 138 that alternates between an I-sample and a Q-sample for every other sample. In one embodiment, digital baseband I- and Q-signals are up-sampled from the baseband frequency to the sample frequency Fₛ through the sample interpolators 133 and 135 prior to processing through the signal construction unit. By up-sampling the I- and Q-signals to the bandpass frequency, the positive and negative sidebands do not have the same physical frequencies. Thus, the present invention avoids performing separate analog signal processing of the I- and Q-channel signals at baseband where both the positive and negative sideband components occupy the same physical frequency.

The I- and Q-signals are latched into the signal construction unit 134. Typically, the latches 204a-b are clocked at the sample rate (e.g., 80 MHz). A selection device 206 (such as one or more multiplexers) forwards the I- and Q-signals to a sampling device 210, such as a commutator. The commutator 210 samples the I- and Q-signals at the sample rate Fₛ to extract the alternating I- and Q-samples according to Equation (9). The commutator 210 is further configured to add a negative reference to the I- and Q-samples, as dictated by Equation (9) and as shown in Table 1, to produce a single transmit signal 212. In one embodiment, the signal construction unit 134 includes a sin(x)/x compensation device 214 followed by a most significant bit (MSB) inverter 216 resulting in the single digital transmit signal 138 at the IF frequency. Thus, the signal construction unit 134 accurately translates the I- and Q-signals to produce the bandpass transmit signal 138 centered at the IF frequency.

In the embodiment shown in FIG. 7, the commutator 210 includes two switches 211 and 213, one for generating the signal 212 with a transmit spectrum centered at the IF frequency (e.g., 60 MHz) and the second for generating a signal 212 with the same transmit spectrum centered at the same frequency but spectrally flipped or inverted. This allows for compensation of other possible spectral inversions that may be present in a system incorporating the transmit signal construction unit 134. Each switch includes four terminals. An I terminal coupled directly to the up-sampled I-signal, a Q terminal coupled directly with the up-sampled Q-signal, a negative I (−I) terminal coupled with an inverter 215 that is coupled directly with the I-signal, and a negative Q (−Q) terminal coupled with an inverter 217 that couples directly with the Q signal. As such, the switches 211, 213 transition between the terminals (I, Q, −I and −Q) to sample the I- and Q-signals at the sample rate Fₛ. The commutator 210 includes a selection device 219, such as a multiplexer, that selects and outputs one of the signals from the switches resulting in the constructed transmit signal 212 with values as shown in Table 1 and defined through Equation (9).

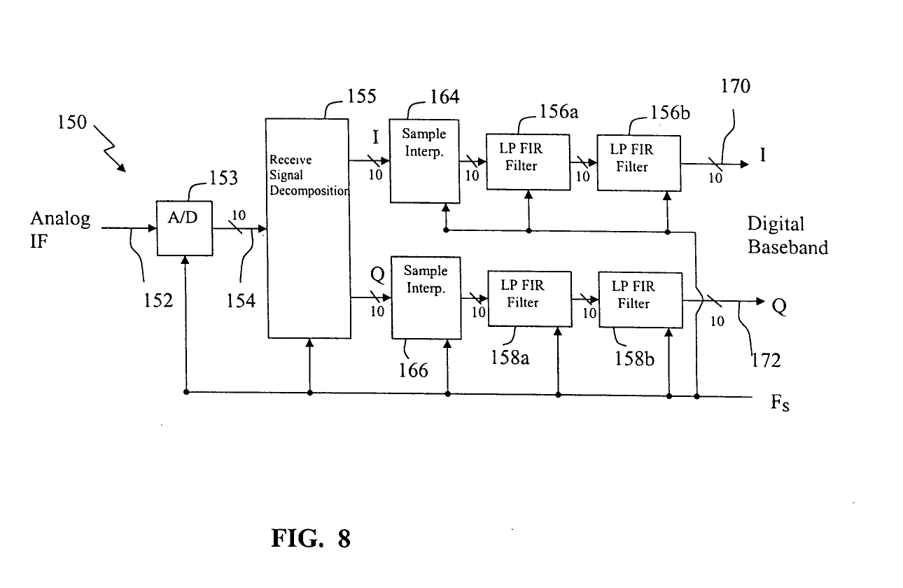

In one embodiment, the present invention additionally performs receive signal decomposition. FIG. 8 depicts a simplified block diagram of one implementation of an apparatus 150 for receive signal decomposition for multicarrier signal processing according to one embodiment of the present invention. In contradiction to previous systems, the present invention initially converts the received analog signal 152 to a digital signal 154 through an analog-to-digital converter (A/D) 153. The apparatus 150 then proceeds to separate the digital receive signal 154 into the I- and Q-signal components and to perform the signal processing in the digital domain. The digital receive signal 154 is decomposed into the I- and Q-signals through a receive signal decomposition unit 155. The decomposition unit 155 samples the receive signal at a sampling rate to maintain the I- and Q-signals at a bandpass frequency. The digital I- and Q-signals are processed through sample interpolators 164 and 166, respectively, providing group delay interpolation at the IF frequency compensating for timing mismatches.

The apparatus 150 filters the digital I- and Q-signals through one or more digital filters 156a-b and 158a-b to produce filtered baseband I- and Q-signals. The digital filters 156, 158 can be substantially any digital filter, such as FIR filters. The first stage of filters 156a and 158a filter the I and Q signals providing the I- and Q-pairs at substantially the same time instance rather than interlaced. Thus, the present invention performs signal decomposition of the multicarrier signals through bandpass sampling in the digital domain, allowing signal decomposition unit 155, sample interpolators 164, 166 and filters 156, 158 to be implemented through digital techniques thus avoiding imbalances in the gain and phase between the I- and Q-channels.

Additionally, because the receive apparatus 150 performs signal processing at bandpass frequencies, unwanted spectrum components and image frequency bands can easily be filtered out through analog filters prior to the A/D converter 153. Further, as is apparent, analog filters do not introduce mismatches between the I- and Q-arms because the filtering is performed on the receive signal 152 prior to separation into the I- and Q-components.

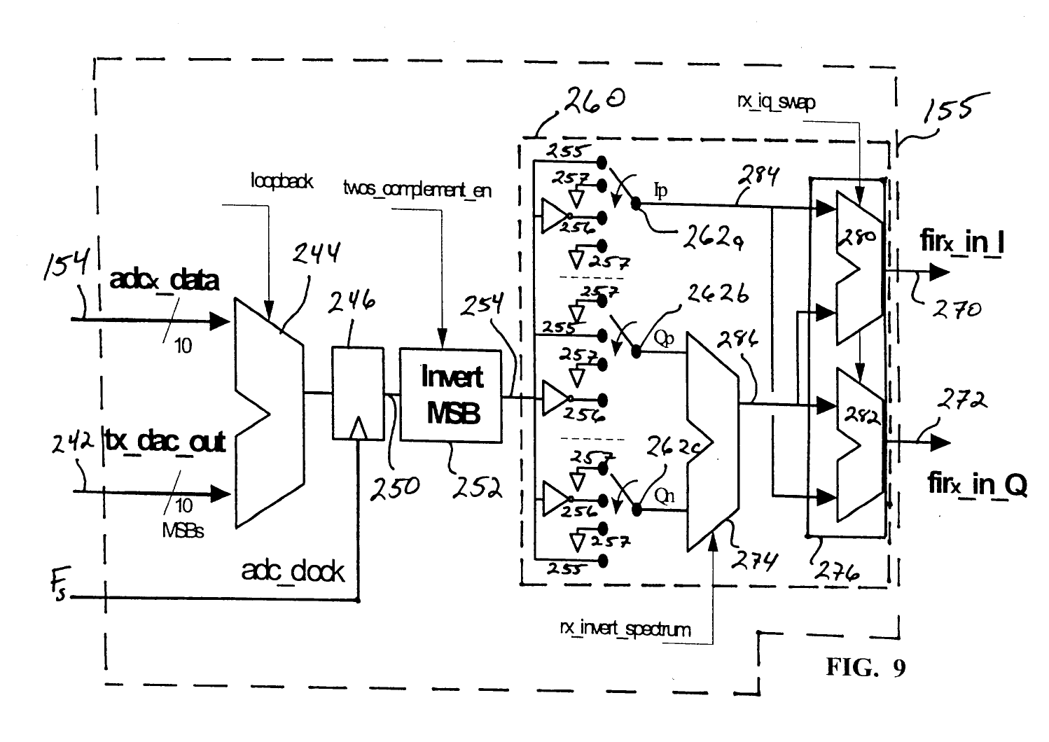

FIG. 9 depicts a simplified block diagram of a receive signal decomposition unit 155 according to one embodiment of the present invention. The decomposition unit 155 receives the digital receive signal 154 where the receive signal is latched in at the sampling rate (Fₛ) by a latch 246. The latched receive signal 250 is forwarded to a MSB inverter 252 followed by a sampling device or commutator 260. The commutator samples the digital receive signal at the sample frequency Fₛ to extract the I- and Q-signals from the receive signal 154. Again taking advantage of the relationship between the sample rate and the IF frequency F_{IF} according to Equation (9), the commutator 260 generates the I- and Q-signals 270, 272. In some embodiments, the I- and Q-signals follow the behavior shown in Table 2.

TABLE 2
Sampled and Commutated Receiver Samples

| Sample Time | | |
|---|---|---|
| Index | I-Channel Output | Q-Channel Output |
| 0 | S₀ | 0 |
| 1 | 0 | S₁ |
| 2 | S₂ | 0 |
| 3 | 0 | S₃ |
| 4 | S₄ | 0 |
| 5 | 0 | S₅ |
| 6 | S₆ | 0 |
| 7 | 0 | S₇ |
| 8 | S₈ | 0 |
| . | . | . |
| . | . | . |
| . | . | . |

The commutator 260 is additionally configured to compensate for the sign inversions produced during the generation of the digital transmit signal 138 by applying appropriate sign inversions, as can be seen in Table 2. Because of the selected IF frequency and sample rate, and their relationship according to Equation (9), the commutator 260 samples the receive signal 254 to alternately extract the I- and the Q-signals while applying a zero value to the corresponding Q- and I-values, respectively. In one embodiment, the signal decomposition unit 155 additionally includes a selection device 244, such as a multiplexer, to select between the digital receive signal 154 and a feedback transmit signal 242 when the receive signal decomposition unit is implemented in a transceiver system and feedback analysis is preformed on a generated transmit signal.

In one embodiment, the commutator 260 includes a plurality of switches 262a-c. Each switch includes four terminals, an input terminal 255 coupled to receive the digital receive signal 254, an inverted input terminal 256 coupled to an inverter to receive an inverted digital receive signal, and one or more zero terminals 257. The commutator 260 transitions through the terminals 255, 256, 257 to provide the sampled receive I- and Q-signals 270, 272 at the sample rate Fₛ. The inverted input terminal 256 provides sign inversion to compensate for the signs resulting from the transmit signal construction. The zero terminals 257 provide the associated zero level outputs for the respective I- and Q-signals as defined by Equation (9) and shown in Table 2.

In one embodiment, the commutator 260 additionally includes a first stage selection device 274 and a second stage selection device 276. The first stage selection device is configured to select between a Q switch 262b and an inverted Q switch 262c providing compensation for spectrum inversion as described above. The second stage selection device 276 selects between a switch generated I-signal 284 and a switch generated Q-signal 286 to produce both I-signal 270 and the Q-signal 272. In one embodiment, the second stage selection device 276 includes two multiplexers 280 and 282 where each select one of the switch generated I-signal 284 and a switch generated Q-signal 286. The dual multiplexers allows for a swap between the switch generated I-signal 284 and a switch generated Q-signal 286 to be selected as the Q-signal and the I-signal respectively. The commutator 260 provides for swapping to allow for spectral inversion.

Referring back to FIG. 8, the I- and Q-digital signals are each forwarded from the receive signal decomposition unit 155 to the sample interpolators 164 and 166. The sample interpolators 164, 166 provide time scale normalization to compensate for mismatches between time bases of transmitting and receiving devices, as fully described below. The 80 MHz I- and Q-signals from the sample interpolators are then forwarded to one or more low pass filters 156a-b and 158a-b. The low pass filters down sample the digital I- and Q-signals 170 and 172. For example, with the sampling frequency at 80 MHz, a first low pass filter 156a and 158a in each of the I- and Q-paths, respectively, can down sample the signals to produce I- and Q-signals by a division of 2 (e.g., from 80 MHz to 40 MHz) and a second pair of low pass filter 156b and 158b can again down sample the signals to a baseband of 20 MHz.

The sample interpolators provide group delay interpolation to compensate for variations and adjustments in the sampling times to coordinate with transmit sampling times and the low pass filters 156, 158 provide inter-sample interpolation between sample indexes. The one or more digital filters 156a-b, 158a-b can be implemented following each sample interpolator 164, 166. The filters 156a-b and 158a-b can be implemented through substantially any sampling filter such as FIR filters and the like.

Again, because the apparatus 150 for signal decomposition operates in the digital domain, the filters 156a-b and 158a-b are digital filters with substantially identical characteristics. Thus, there is substantially zero delay and gain mismatching between the I- and Q-arms. The filters remove adjacent channel energy if present and can be utilized to reduce the sampling rate to a minimum convenient rate dictated by the Nyquist criterion.

In one embodiment, the present invention derives a carrier frequency and symbol clocks from a single precision standard. As such, the present invention can provide multi-carrier modulation while holding sufficiently accurate timing to derive symbol timing. The present invention maintains a direct correlation between the frequency and time.

Previous systems have attempted to maintain the tight coupling requirement between carrier and symbol frequencies by deriving them both directly from a voltage controlled crystal oscillator (VCXO) precision crystal reference. However, this entails additional cost and additional technical issues such as, unreliable and/or inconsistent VCXO performance, difficulty of going off-chip to drive the VCXO, and problems with the speed at which frequency corrections can be applied to the system.

In compensating for the slight time-base differences between a transmitter and a receiver, the sample interpolators expand or contract time. This is done by mathematically changing the group delay through the sample interpolators versus time. The present invention additionally limits the group delay variation across the modulation bandwidth at substantially any specific time to very small variations, as described above. The present invention provides group-delay interpolation which allows the present invention to avoid needing a precision VCXO while still maintaining a precise balance between I- and Q-channels.

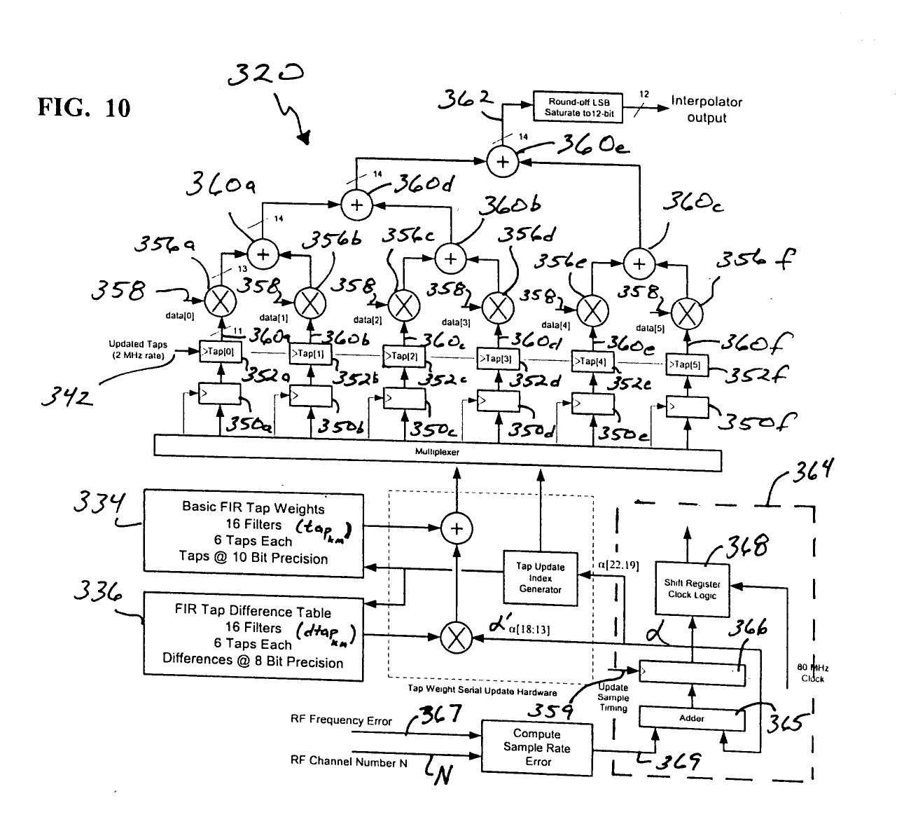

FIG. 10 depicts a simplified block diagram of an FIR-based sample interpolator 320 according to one embodiment of the present invention that can be utilized in the signal construction (or transmit) system 120 and/or signal decomposition (or receive) system 150. The interpolator shown is for one of the I- or Q-arms; however, because both arms are processed in a similar manner, the interpolator shown in FIG. 10 can be simply repeated for the other arm. The sample interpolator 320 operates in the I- and Q-signal paths at the sampling rate Fₛ providing superior overall system performance and requiring fewer gates to implement than if implemented at a lower sampling rate later in the chain (for receiving) and/or earlier in the chain (for transmitting).

In the embodiment shown in FIG. 10, the digital sample interpolator uses a filter length with a plurality of taps. The underlying FIR interpolation filters of the I- and Q-paths utilize substantially identical tap weights at substantially all times. This allows the present invention to further avoid imbalance problems between I- and Q-paths. By implementing the sample interpolator through digital means, precisely controlled group delays can be achieved allowing the present invention to avoid using a VCXO.

In one embodiment, the basic structure is a 6-tap FIR with adjustable coefficients. However, substantially any number of taps can be utilized depending on the accuracy desired and the allowable complexity of the circuit design. In the course of interpolating for different fractional sample intervals, the filter coefficients are generally not symmetrical. Therefore, the filter structure includes a multiplier 330a-f for each tap weight 360.

Still referring to FIG. 10, the delay-line structure for the I-channel is shown, and as already stated, the filter operations for the I- and Q-channels utilize substantially identical tap weights at all times. The underlying FIR filters are 6 taps in length, utilizing for example 2's complement coefficients. The time-span of [0,1.0) samples is covered by 16 different FIR filters. The 16 different FIR filter tap coefficients tap_{k,m} are stored in a first memory block 334 where tap_{k,m} represents the m^{th} tap for the k^{th} FIR filter. Tap weight differences dtap_{k,m} are stored in second memory block 336, where dtap_{k,m}=tap_{k+1,m}−tap_{k,m} represents the tap difference between the k+1 FIR filter and the k^{th} filter for the m^{th} tap. An interpolation parameter α defines interpolation between adjacent samples using the FIR filters, and spans the range [0.0,1.0) in floating point context. The tap weights being used at a given time in the FIR filters are given by:

gtapₘ=tapₘ+α′*dtap_{k,m}, (10)

for m=[0:5], where the k and α values depend upon the interpolation increment being computed.

In one embodiment, the FIR filter tap weights 360 receive an up-date 342 at a predefined rate, for example at a 2 MHz rate. This provides a slow enough rate that tap weights can be computed in a serial manner. A double-buffering scheme is utilizes 350a-f, 352a-f allowing the tap weights to be serially updated, and then presented in parallel to the FIR structure 320 at the appropriate time.

The FIR filter structure 320 provides: (a) substantially flat group delay across the baseband bandwidth regardless of the interpolation parameter α; and (b) easy adjustment of a change in delay through the filter in a linear manner.

In one embodiment, the interpolator 320 provides elasticity to accommodate timebase mismatches. The interpolator is configured to handle and compensate for time errors, for example, time errors up to ±7 samples or more, where errors up to ±7 samples (at 80 MHz) corresponding to ±87.5 nsec over a 1 msec time burst which is equivalent to ±87.5 ppm. The level of time error compensation can be substantially any level depending on the complexity, and the number of taps and weights utilized in the interpolator 320.

In one embodiment, an underlying FIR impulse response used is a raised-cosine with an excess bandwidth parameter β of 0.50. A total of 16 different tap-weight sets are chosen to span the interpolation period of [0.0,1.0) samples at the sample rate Fₛ (e.g., 80 MHz or 12.5 nsec total). The additional interpolation of FIR tap-weights is included providing a more fine-grained time resolution without adding additional FIR filter tap weight coefficients. As discussed above, it is desirable to be able to increment time in order to avoid introducing harmful phase perturbations to the multi-carrier (e.g., OFDM) subcarriers, for example, on the order of less than 0.40 nsec.

Previous systems in attempting to increment time on the order of less than 0.40 nsec, for example 0.25 nsec to be conservative, would require expanding the number of FIR filter choices to cover an entire 12.5 nsec range to 12.5/0.25=50 filters. The present sample interpolator 320 provides almost unlimitedly small interpolation increments that are more advantageous. In some embodiments, a transceiver system may utilize additional subcarriers that dictate even smaller time increment precision.

Still referring to FIG. 10, the tap weights 360 are double-buffered 350a-f, 352a-f as described above, to permit serial computation of the new tap weights while retaining use of the previously computed weights until new taps have been computed and are ready for use. Six multipliers 356a-f are shown for the 6-tap FIR filter, where tapped delay-line data values 358a-f (data[k]) are multiplexed with the weighted outputs 360a-f. The weighted shift-register samples are combined in a tree of adders 360a-e forming a resultant filter output sample 362.

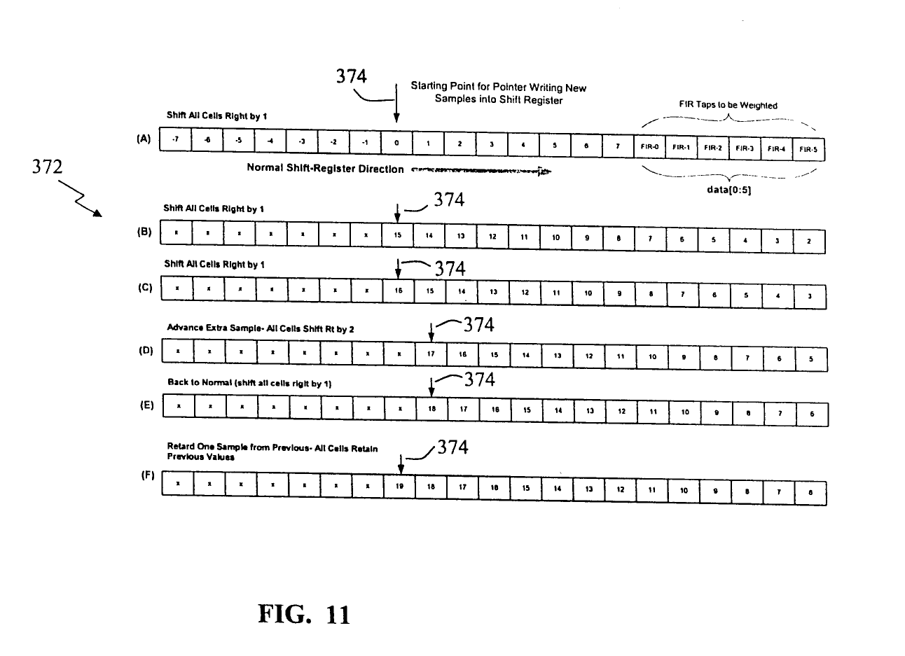

FIG. 11 shows a plurality of different delay-line scenarios (A)-(F) for delay line shift registers 372. At the beginning of a burst, such as a MAC burst or user burst, a write pointer 374 is positioned to a 0^{th} cell as shown in the shift register scenario (A), where new samples are repeatedly written into the 0^{th} cell. Under normal operations, the shift-register contents are shifted right one cell for example, on the leading edge of the internal clock (e.g., an 80 MHz clock). Small frequency mismatches between the signal's symbol rate and the symbol rate as referenced to an internal 20 MHz precision reference may cause misalignment. The present invention compensates for this misalignment by occasionally altering the shifting sequence. In one embodiment, two types of compensation are provided for depending upon whether the local precision reference oscillator is too high or too low in frequency compared to an ideal reference frequency.

In a first case, the precision reference oscillator is too low in frequency. As a result the present system shifts and takes a few less samples than ideal to cover a fixed time duration. The filter impulse response is effectively shifted from right to left across the tap weights. The impulse response continues until an accumulator underflow condition is reached. When an underflow condition is reached all of the shift register contents are shifted to the right an extra cell (e.g., shifted to the right by two (2) cells rather than the normal one (1) cell). As such, the write-pointer 374 is bumped one additional cell to the right and new input sample values are loaded into the cell designated by the pointer 374.

In a second case, the precision reference oscillator is too high in frequency. As a result, the system ends up taking a few more samples than normal to cover a fixed time duration. The filter impulse response is effectively shifted from left to right across the tap weights until an accumulator overflow condition occurs. When the overflow condition occurs the write-pointer 374 is bumped one additional cell to the left and the new input sample is loaded into that cell while the other shift register contents are not shifted for one clock period.

Still referring to FIG. 11, the data shift register scenario (B) corresponds to a shift-right under normal operation where register contents are shifted one cell to the right at the clock edge and no adjustment is made to the write-pointer 374. The shift register scenario (C) depicts a second normal shift-right operation where register contents are shifted one cell to the right. In the shift register scenario (D), the presumption is that the local precision reference is a bit too low in frequency resulting in an eventual accumulator underflow condition that triggers an adjustment to the right of the write-pointer 374 and all cell contents being shifted right 2 cells rather than 1 cell. In the shift register scenario (E) a normal shift-right operation continues with the new write-pointer location used, but operation is otherwise the same as for register scenarios (A) and (B). The register scenario (F) illustrates the case where the local precision reference is a bit too high in frequency, resulting in an eventual accumulator overflow condition triggering and adjustment (to the left) of the write-pointer 374 and all cell contents not being advanced for one clock cycle.

As discussed above, the present invention can be implemented utilizing a single precision reference. Further, the present invention typically does not employ an external or off-chip VCXO, and preferably avoids the use of an off-chip VCXO. Alternatively, the present invention achieves time adjustments to the signal precision reference through, at least in part, one or more sample interpolators 133, 135, 164, 166 and/or 320.

In one embodiment, this time adjustment is directly related to a measured frequency and/or phase error. The present invention typically maintains a strict correlation between the frequency and time, such that if there is an adjustment to one, the other is proportionally adjusted.

Referring back to FIG. 10, in one embodiment, the sample interpolator 320 incorporates an integrator 364. In the embodiment shown in FIG. 10, the integrator 364 includes a 23-bit wide adder 365 and register or accumulator 366 combination. An RF frequency error 367 is compared with an RF channel number N, which is typically the RF center frequency. A frequency error rate or ratio 369 is determined.

The error ratio is received by the adder 365 along with a feedback of an interpolation parameter α generated by the adder 365 and register 366 combination. The adder sums the RF frequency error ratio 369 and the feedback of the interpolation parameter α and forwards the results to the register 366, where the register holds the summation. The adder and register combination provide scaling of the RF frequency error and integrates this error into the sample interpolator 320 initiating the time adjustments to maintain the precision reference. The integrator 364 can operate at a 2 MHz clock rate 359 that is derived from the same precision reference used elsewhere in the apparatus. In one embodiment, the integrator 364 is implemented through a numerically controlled oscillator (NCO) 364. However, the NCO does not overflow or underflow.

The RF frequency error can be generated from any of a plurality of devices monitoring the RF frequency, including, but not limited to, a phase-lock loop (PLL), a digital phase-lock loop (DPLL) and the like. One example of generating the RF frequency error is fully described in co-pending U.S. patent applications entitled, “OPTIMUM PHASE ERROR METRIC FOR OFDM PILOT TONE TRACKING IN WIRELESS LAN”, application Ser. No. 09/790,429, filed Feb. 21, 2001, “OFDM PILOT TONE TRACKING FOR WIRELESS LAN,” application Ser. No. 09/935,081, filed Aug. 21, 2001, and “OFDM PILOT TONE TRACKING FOR WIRELESS LAN,” application Ser. No. 09/935,243, filed Aug. 21, 2001, which are all fully incorporated herein by references. In one embodiment, the RF frequency error is continuously updated at the RF frequency (e.g., 5 GHz), as compared with the local precision time base. For example, the continuous RF frequency error can be supplied by a DPLL to allow the integrator 364 to provide precise time adjustments to the sample interpolator 320. The sample interpolator 320 utilizes the RF frequency error to provide precise symbol time tracking accuracy. For example, a DPLL can estimate an RF frequency error to within a few 10s of Hertz (e.g., to within ±50 Hz out of 5 GHz) to provide accuracies to less than 1 ppm (e.g., RF frequency errors of ±50 Hz allows accuracies of within ±0.01 ppm). The present invention associates the group delay interpolation correction factor to a precision measure of correction based on a frequency error.

In one embodiment, the interpolation parameter α is forwarded to a shift register clock logic 368 to implement clock adjustments as described above with reference to FIG. 11. The four most significant bits (MSB) of the interpolation parameter α (e.g., bits 22-19) are further utilized by a tap update index generator for the generation of tap indexes which are forwarded to the memories 334 and 336 as well as the double buffering scheme 350, 352, to be used to index which FIR taps and tap differences are used in Equation (10) for the calculation of gtapₘ, as described above. The next six MSBs indicated as α′ (e.g., bits 18-13) are multiplied with the tap weight difference in Equation (10) to be added with the tap coefficients.

The sample interpolator provides the timing compensation for the systems 120, 150. Further, the sample interpolator maintains the correlation between the frequency and timing, providing precision timing based on a single precision reference. The sample interpolator maintains the correlation between the frequency and timing such that adjustments made to compensate for frequency errors are equally adjusted to compensate for timing errors. As such, in one embodiment, the precision timing is maintained through the tracking of the frequency error.

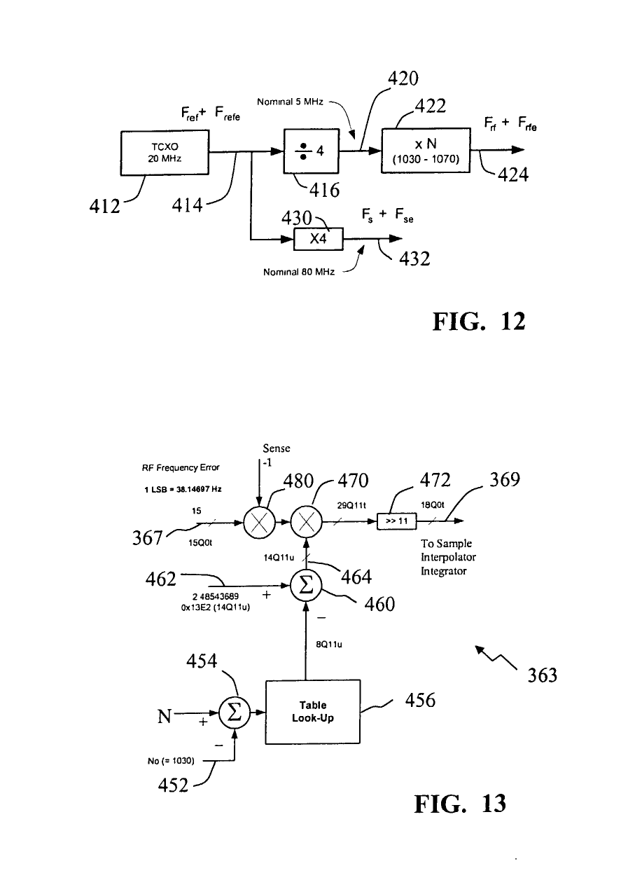

As stated earlier, the RF and symbol-rate frequencies are effectively tied to the same precise master reference oscillator. Because the present invention does not go off-chip to physically tune a VCXO to perform the RF carrier tracking, the tracking is performed in one embodiment in VLSI computations. FIG. 12 depicts a simplified block diagram showing the relationship between the RF frequency errors and sample-rate frequency errors. A reference signal 414 is generated from an oscillator 412 (for example, a temperature compensated crystal oscillator). The reference signal has a reference frequency F_{ref} (e.g., 20 MHz) plus a reference frequency error F_{refe}. An RF signal 424 is generated by dividing (416) the reference signal (for example, dividing by 4) and multiplying by N (422) where N can be, for example, between 1030 and 1070. The resulting RF signal has an RF frequency F_{rf} and an RF frequency error F_{rfe}. The sample signal 432 is generated from the reference signal 414 by multiplying (430) by a sampling factor (for example, by a factor of four). The sample signal has a sample frequency Fₛ plus a sample error frequency Fₛₑ. The frequency used by the xN block 422 can be, for example, 5 MHz. In one embodiment, the channel number as defined in IEEE802.11a/HiperLAN2 is based upon 5 MHz increments starting at 5 GHz.

In one embodiment, the present invention utilizes a TCXO that remains free-running. Frequency errors in the 5 GHz received signal are detected and removed, for example through a PLL, DPLL and/or a Pilot tracking module. The present invention does not modify the frequency of the TCXO, but alternatively utilizes the sample interpolator 320 to provide appropriate corrections mathematically to the internal signal samples. As described above, previous devices alternatively utilize a VCXO, where any measured error in the received carrier frequency results in a modification being made to the VCXO precision reference frequency thereby automatically changing the sampling rate (and hence the symbol rate) appropriately.

Below is described how the sample interpolator mathematical time adjustments are related to the RF frequency error corrected by, for example, a DPLL phase error, VCTXO calibrated frequency, and/or coarse and fine frequency error.

As one example, the TCXO can provide a 20 MHz crystal oscillator reference, which has a frequency error compared to the precision reference of F_{refe} Hz (see FIG. 12). The corresponding RF frequency error F_{rfe} at the RF channel center frequency can be calculated as:

$${F}_{rfe} = N * \frac{{F}_{refe}}{4} , \qquad ( 11 )$$

with N being an integer multiple of 5 MHz corresponding to the RF channel center frequency. The corresponding sample rate frequency error Fₛₑ, with the sampling rate frequency at, for example, 80 MHz, can be calculated by:

Fₛₑ=4*F_{refe} (12)

From equation 11, a frequency step size in an RF phase rotator can be defined by dFᵣₒₜ=40 MHz/2²⁰=38.14697266 Hz (at 40 MHz) and dFᵣₒₜ=20 MHz/2²⁰=19.07348633 Hz (at 20 MHz).

The sample timing is typically adjusted every T_{UP} seconds. As such the amount of time adjustment needed for a given RF frequency error (for example, in terms of 12.5 nsec sample units) can be calculated by:

$$Δ s = {F}_{se} {T}_{UP} = \frac{16 {F}_{rfe}}{N} {T}_{UP} , \qquad ( 13 )$$

where, in one embodiment, N ranges from 1030 to 1070 (corresponding to 5.15 GHz to 5.35 GHz). Since the RF frequency error precision is limited to dFᵣₒₜ, this translates to a minimum time adjustment size in the 80 MHz sampler of:

$$\begin{matrix}\begin{matrix}Δ {s}_{min} = \frac{16 {dF}_{rot}}{N} {T}_{UP} , \\ or\end{matrix} & ( 14 ) \\ Δ {s}_{min} = \frac{5}{N} {2}^{- 14} ( units of 12.5 nsec samples ) . & ( 15 )\end{matrix}$$

To demonstrate the order of magnitude of this quantity, it is assumed that N=Nₙₒₘ=1050. Further, it is assumed that the bit-width of the integrator 364 used in the sample interpolator 320 is L. The amount of sample time adjustment per LSB from that integrator is given by:

$$Δ {s}_{si} = \frac{1}{{2}^{L}} \qquad ( 16 )$$

The scaling factor that relates the Δsₘᵢₙ corresponding to the minimum RF frequency adjustment realized by the integrator 364 in the sample interpolator is calculated by:

$$γ = \frac{5 * {2}^{L - 14}}{N} , ( {T}_{UP} = 0.5 usec ) . \qquad ( 17 )$$

Referring to Table 3, the number of bits utilized in the sample interpolator integrator 364 to deliver the increments shown for T_{UP}=0.5 usec is 22 bits. Taking L=23 bits to achieve a margin of error, equation 17 results in γ=2560/N or 2.48544 for N=1030 and 2.392523 for N=1070.

TABLE 3
Minimum Sample Increment Versus Key Parameters

| Mode | T_{UP} = 0.5 μsec | T_{UP} = 1 μsec | T_{UP} = 2 μsec |
|---|---|---|---|
| RF Integrator, | 2.90644e−7 | 5.81287e−7 | 1.1626e−6 |
| LSB = 38.147 Hz | | | |

FIG. 13 depicts a simplified schematic diagram of one implementation of a component 363 for determining the sample rate error according to one embodiment of the present invention. The RF channel number N is summed 454 with a reference number 452. Summation results are utilized in a look up table 456. The resulting factor from the look up table is summed 460 with a scaling factor 462 (γ). The summation result 464 is multiplied 470 with the RF frequency error 367, resulting in the RF frequency error ratio 369. In one embodiment, the 18 MSBs of the RF frequency ratio are forwarded to the integrator 364. For example, the RF frequency error 367 can be 15 bits, and the table and scaling factor summation 464 can be 14 bits resulting in a 29 bit RF frequency error ratio 369. As such, a reduction of 11 bits 472 is implemented.

In one embodiment, the table look-up 456 provides quantities that are assumed to be strictly positive values. The table and scaling factor summation 14 bit word 464 and the output from the multiplier 470 are both 2's complement format.

Table 4 shows an example of the table look-up 456 with hexadecimal values provided on the far right-hand column versus N.

TABLE 4
Table Look-Up for Conversion Factor from RF
Frequency Error to Sample Rate Correction

| N | Factor | Delta | Decimal |
|---|---|---|---|
| 1030 | 2.485436893 | 0 | 0 |
| 1031 | 2.483026188 | −0.00241071 | 5 |
| 1032 | 2.480620155 | −0.00481674 | 10 |
| 1033 | 2.47821878 | −0.00721811 | 15 |
| 1034 | 2.47582205 | −0.00961484 | 20 |
| 1035 | 2.473429952 | −0.01200694 | 25 |
| 1036 | 2.471042471 | −0.01439442 | 29 |
| 1037 | 2.468659595 | −0.0167773 | 34 |
| 1038 | 2.46628131 | −0.01915558 | 39 |
| 1039 | 2.463907603 | −0.02152929 | 44 |
| 1040 | 2.461538462 | −0.02389843 | 49 |
| 1041 | 2.459173871 | −0.02626302 | 54 |
| 1042 | 2.45681382 | −0.02862307 | 59 |
| 1043 | 2.454458293 | −0.0309786 | 63 |
| 1044 | 2.45210728 | −0.03332961 | 68 |
| 1045 | 2.449760766 | −0.03567613 | 73 |
| 1046 | 2.447418738 | −0.03801816 | 78 |
| 1047 | 2.445081184 | −0.04035571 | 83 |
| 1048 | 2.442748092 | −0.0426888 | 87 |
| 1049 | 2.440419447 | −0.04501745 | 92 |
| 1050 | 2.438095238 | −0.04734166 | 97 |
| 1051 | 2.435775452 | −0.04966144 | 102 |
| 1052 | 2.433460076 | −0.05197682 | 106 |
| 1053 | 2.431149098 | −0.0542878 | 111 |
| 1054 | 2.428842505 | −0.05659439 | 116 |
| 1055 | 2.426540284 | −0.05889661 | 121 |
| 1056 | 2.424242424 | −0.06119447 | 125 |
| 1057 | 2.421948912 | −0.06348798 | 130 |
| 1058 | 2.419659735 | −0.06577716 | 135 |
| 1059 | 2.417374882 | −0.06806201 | 139 |
| 1060 | 2.41509434 | −0.07034255 | 144 |
| 1061 | 2.412818096 | −0.0726188 | 149 |
| 1062 | 2.410546139 | −0.07489075 | 153 |
| 1063 | 2.408278457 | −0.07715844 | 158 |
| 1064 | 2.406015038 | −0.07942186 | 163 |
| 1065 | 2.403755869 | −0.08168102 | 167 |
| 1066 | 2.401500938 | −0.08393596 | 172 |
| 1067 | 2.399250234 | −0.08618666 | 177 |
| 1068 | 2.397003745 | −0.08843315 | 181 |
| 1069 | 2.394761459 | −0.09067543 | 186 |
| 1070 | 2.392523364 | −0.09291353 | 190 |

In one embodiment, the polarity of the error provided to the component 363 for determining the sample rate error in FIGS. 10 and 13 can be confused, so a polarity switch 480 supplied to the component 363 which typically is ultimately removed or hard-wired in. The RF frequency error 367 fed to the sample interpolator 320 is assumed to be properly altered as needed between transmit and receive operations where, in one embodiment, the input and output ports of the sample interpolator are effectively flipped between receive and transmit operations.

The sample interpolator 320 can be implemented to use frequency error data 367 of 15 bits and assumes, in one embodiment, the LSB of the frequency error word represents 38.147 Hz. As such, in 20 MHz sample mode (as defined by the 802.11a standard) the frequency word is shifted by 1-bit to the right, effectively providing a divide-by-two operation.

The signal construction system 120 and signal decomposition system 150 can be implemented in substantially any communication system, and particularly for multicarrier communication systems (e.g., OFDM). One example is with wireless communication, such as a wireless inter-office or inter-home networks where one or more access points (AP) communicate with one or more remote terminals (RT). In one embodiment, the signal construction system 120 for generating transmit signals, and signal decomposition systems 150 for signal reception each operate on a time base. In most instances these time bases between communicating AP and RT systems may not be equivalent, and they may fluctuate over time resulting in unequal time bases.

Typically, a transmitter's time base should match a cooperating receiver's time base to achieve optimal communication. For example, an RT's time base should match the AP's time base in order to achieve optimal tracking with the AP. Due to the mismatch, a receiver may have some time elasticity where the precision reference in the receiver could be a little higher in frequency or a little lower in frequency (e.g., differences of less than one ppm, about a few parts per million, and up to thousands of ppm) than the time base of a corresponding transmitter. In optimizing communication, an RT utilizing the present invention attempts to match the frequency and time requirements of the AP when the RT sends a signal back to the AP. As such, the RT attempts to mimic the time base of the AP as if the RT had almost exactly the same time base as the AP.

As a further example, assuming an AP transmitter's precision reference is perfect at 20 MHz and is transmitting on an RF center frequency of 5.150 MHz. Further assuming that an RT's precision reference is experiencing a 15 parts per million (ppm) error. When the RT tunes to what it believes is the 5150 MHz, the RF frequency error detection device (e.g., DPLL) determines that there is a frequency error of 15*(5150×10⁶), which equals 77,250 Hz. The RF frequency error is forwarded to the integrator 364 which calculates that the sampling times are to be corrected (e.g., through the sample interpolator) by (77,250/5150×10⁶)=15 ppm. Typically, the time base adjustment by the sample interpolator is continuously adjusted at a fixed rate (e.g., 2 MHz) as described above.

The present invention is capable of achieving precise timing adjustments by corresponding the time adjustments to the adjustments made to compensate for frequency errors. For example, if the RF center frequency is 5.150 GHz, and a frequency error is measured to within 100 Hz (for example, through a DPLL), then in terms of parts per million (ppm), the sample clock frequency error is 100/5.15 GHz=0.0194 ppm. In operating under the 802.11a standard, the highest subcarrier frequency is about 8.5 MHz. In order to achieve a phase accuracy of one (1) degree (due to the sampling clock accuracy) over a 2 msec time frame, a correction to the precision time base that is needed is a correction to within ((1/360)/8.5 MHz)/2 msec=0.1634 ppm. As can be seen, the present invention easily achieves an accuracy of 0.0388 ppm, which is a significantly greater accuracy than the 0.1634 ppm for the 1 degree accuracy under the 802.11a standard.

In some embodiments of the signal construction system 120 and signal decomposition system 150, the filters 130, 132, 156 and 158 provide, at least in part, fine grain time scaling of the time base. Further, the sample interpolators 133, 135, 164 and 166 accommodate, at least in part, for this elasticity in the time domain over a greater scale providing coarse adjustments.

As described above, the sample interpolator may provide cell shifts. For example, the sample interpolator may shift plus or minus samples (e.g., up to seven samples) at 80 MHz in the course of milliseconds or less due to differences between the AP and RT's precision references (e.g., as little as few parts per million difference). Thus, the present invention utilizes the filters 130, 132, 156 and 158 to provide inter-sample interpolation over a more fine grain time scale, whereas the sample interpolators 133, 135, 164 and 166 provide group delay interpolation to accommodate for the elasticity in the time domain over a greater scale. These coarse and fine adjustment capabilities allow the time base between communicating systems to adjust, such as allowing the RT (and AP) to adjust its time base in an attempt to match the AP (and RT) time base.

In one embodiment, a single sample interpolator is shared between both the transmit and receive operations since the sample interpolator function is substantially identical for both the transmit and receive arms.

The FIR filters of the sample interpolator 320 are implemented through digital means. As such, the FIR filters of the I- and Q-arms are precisely balanced to provide substantially identical gain and substantially identical delay. Therefore, the FIR filters do not introduce mismatches between the I- and Q-arms, thus avoiding the problems seen in previous systems.

As can be seen by Tables 1 and 2 (and FIGS. 6-9), the I- and Q-values are supplied by the present invention at different time sample index values for transmit mode and made available by the present invention at different index values in receive mode. To achieve high performance multicarrier modulation and demodulation, such as with OFDM, it is of particular importance to sample the I- and Q-signals at substantially identical time instances. As such, substantially zero delay imbalance can be tolerated in the I- and Q-channel processing.

The present invention achieves this substantially zero imbalance in I- and Q-channel processing by utilizing substantially identical digital filters (for example, filters 130, 132, 156, 158 and the sample interpolator 133, 135, 164, 166). In one embodiment, lowpass FIR filters are utilized for the I- and Q-baseband channels having a sampling rate Fₛ. Because these filters are implemented in the digital domain, they can be made substantially identical. Thus, these filters introduce zero imbalances upon the I- and Q-channels, and provide precision multicarrier modulation and demodulation.

Additionally, the sampling at the sample rate Fₛ centered at the IF frequency F_{IF} allows the present invention to rapidly recover from being over driven. Previous systems utilizing IQ analog filters may be over driven by inconsistent gains of different receive signals. Previous systems operating at new zero IF cannot recover quickly enough to continue to provide accurate demodulation. Operating at near zero IF requires filtering after the quadrature mixing to have both low-pass and high-pass filter elements. The speed of measurements with multicarrier modulation makes these implementations extremely difficult, if at all possible, and impractical. However, the present invention samples at an IF frequency much greater than zero (e.g., 80 MHz) allowing much faster recover than seen with systems operating at near zero IF. Thus, the present invention significantly reduces, if not eliminates the adverse affects seen with over driven filters when demodulating a receive signal.

While the invention herein disclosed has been described by means of specific embodiments and applications thereof, numerous modifications and variations could be made thereto by those skilled in the art without departing from the scope of the invention set forth in the claims.

What is claimed is:

1. A method for multicarrier signal modulation, comprising the steps of:
maintaining substantially identical gain and group delays between transmit in-phase (I) and transmit quadrature-phase (Q) paths, comprising:
receiving a transmit I digital baseband signal and a transmit Q digital baseband signal of a first multicarrier communication signal;
digitally constructing a digital transmit intermediate frequency (IF) signal from the transmit I and Q digital baseband signals including bandpass sampling, wherein bin-by-bin amplitude and delay resulting in the I path is substantially equal to bin-by-bin amplitude and delay resulting in the Q path; and
converting the digital transmit IF signal to an analog transmit IF signal.

2. The method as claimed in claim 1, wherein the step of digitally constructing avoids bin-by-bin amplitude and delay imbalances between positive and negative frequency components.

3. The method as claimed in claim 1, further comprising the step of:
providing group delay interpolation at the IF frequency and compensating for sample clock timing mismatches.

4. The method as claimed in claim 3, further comprising the step of:
avoiding the use of a voltage controlled crystal oscillator for sample clock timing adjustments while maintaining substantially identical gain and phase balance between the I and Q signals.

5. The method as claimed in claim 1, further comprising the steps of:
determining RF frequency errors from the I- and Q-signals; and
implementing time base adjustments of the I- and Q-signals based on the RF frequency errors.

6. The method as claimed in claim 1, further comprising the steps of:
maintaining substantially identical gain and group delays between receive I and receive Q paths, comprising:
receiving an analog receive IF signal of a second multicarrier communication signal;
converting the analog receive IF signal to a digital receive IF signal;
digitally decomposing the digital receive IF signal into a receive I digital IF signal and a receive Q digital IF signal; and
down sampling the receive I and Q digital IF signals into a receive I digital baseband signal and a receive Q digital baseband signal.

7. The method as claimed in claim 3, wherein the step of digitally decomposing avoids bin-by-bin amplitude and phase imbalances between positive and negative frequency components.

8. The method as claimed in claim 1, wherein the step of bandpass sampling includes utilizing digital I and Q signals at first digital image frequencies.

9. The method as claimed in claim 8, wherein the step of digitally constructing the digital IF signal includes digitally interpolating each of the digital I and Q signals and compensating for timing errors.

10. The method as claimed in claim 9, wherein the step of compensating for timing errors includes determining timing adjustments based on frequency errors.

11. A method for multicarrier signal conditioning for communication, comprising the steps of:
receiving an analog receive intermediate frequency (IF) signal of a first multicarrier communication signal;
converting the analog receive IF signal to a digital receive IF signal;
commutating the digital receive IF signal producing a digital receive I bandpass signal and a digital receive Q bandpass signals;
interpolating the digital receive Q bandpass signal;
interpolating the digital receive I bandpass signal; and
generating digital receive I baseband signal and a digital receive Q baseband signal.

12. The method as claimed in claim 11, wherein the step of interpolating the digital receive Q bandpass signal including implementing group delay interpolation of the digital receive Q baseband signal, and the step of interpolating the digital receive I bandpass signal including implementing group delay interpolation of the digital receive I baseband signal.

13. The method as claimed in claim 12, wherein the steps of interpolating the digital receive Q bandpass signal and interpolating the digital receive I bandpass signal include avoiding using a voltage controlled crystal oscillator while maintaining precise gain and amplitude balance between the I and Q signals.

14. The method as claimed in claim 11, further comprising the steps of:
measuring a frequency error;
compensating for timing in the digital receive Q bandpass signal based on the frequency error; and
compensating for timing in the digital receive I bandpass signal based on the frequency error.

15. The method as claimed in claim 11, further comprising the steps of:
maintaining amplitude and phase balance between the I bandpass signal and the Q bandpass signal; and
avoiding bin-by-bin imbalances between positive and negative frequency components of the I bandpass signal and the Q bandpass signal.

16. The method as claimed in claim 11, further comprising the steps of:
receiving a digital transmit I baseband signal and a digital transmit Q baseband signal of a second multicarrier communication signal;
generating digital transmit I and Q bandpass signals;
interpolating the digital transmit I and Q bandpass signals;
digitally commutating the digital transmit I and Q bandpass signals producing a digital transmit IF signal; and
converting the digital transmit IF signal to an analog transmit IF signal.

17. The method as claimed in claim 11, further comprising the step of:
maintaining substantially identical gain and group delays between I and Q signal paths during the steps of commutating the digital receive IF signal, interpolating the digital receive I and Q bandpass signals, and generating digital receive I and Q baseband signals.

18. The method as claimed in claim 11, further comprising the step of:
avoiding the need to perform analog processing of I- and Q-signals where both positive and negative sideband components occupy the same physical frequency at baseband.

19. The method as claimed in claim 11, wherein the steps of generating digital I and Q bandpass signals, interpolating the digital I bandpass signal, interpolating the digital Q bandpass signal and commutating the digital I and Q bandpass signal avoid gain and group delay imbalances between I and Q baseband anti-aliasing analog filters.

20. An apparatus for multicarrier signal processing, comprising:
a first interpolator coupled to receive digital bandpass in-phase (I) signal of a multicarrier signal, and configured to adjust a delay of digital bandpass I signal;
a second interpolator coupled to receive digital bandpass quadrature-phase (Q) signal of a multicarrier signal, and configured to adjust a delay of digital bandpass Q signal;
a transmit signal construction unit coupled with the first and second interpolators, and configured to construct a digital IF transmit signal from the adjusted digital bandpass I and Q signals; and
a digital-to-analog converter coupled with the transmit signal construction unit to receive the digital IF transmit signal, and configured to convert the digital IF transmit signal to an analog IF transmit signal.

21. The apparatus as claimed in claim 20, wherein:
the first interpolator includes a first sample interpolator providing group delay interpolation; and
the second interpolator includes a second sample interpolator providing group delay interpolation.

22. The apparatus as claimed in claim 21, wherein the first and second interpolators are further configured to provide timing adjustments based on a measured frequency error.

23. The apparatus as claimed in claim 21, wherein
the first interpolator includes a first filter providing inter-sample interpolation; and
the second interpolator includes a second filter providing inter-sample interpolation.

24. The apparatus as claimed in claim 20, wherein:
the transmit signal construction unit includes a commutator configured to receive the adjusted digital bandpass I and Q signals and to sample the adjusted digital bandpass I and Q signals.

25. An apparatus for multicarrier signal processing, comprising:
a analog-to-digital converter configured to receive an analog IF receive signal of a multicarrier signal and to convert the analog IF receive signal to a digital IF receive signal;
a receive signal decomposition unit coupled with the analog-to-digital converter, and configured to decompose the digital IF receive signal into a digital IF in-phase (I) receive signal and digital IF quadrature-phase (Q) receive signal;
a first interpolator coupled with the decomposition unit to receive the digital I receive signal, and configured to adjust a delay of digital I receive signal producing digital bandpass I receive signal; and
a second interpolator coupled with the decomposition unit to receive the digital Q receive signal, and configured to adjust a delay of digital Q receive signal producing digital bandpass Q receive signal.

26. The apparatus as claimed in claim 25, wherein:
the first interpolator includes a first sample interpolator providing group delay interpolation;
the second interpolator includes a second sample interpolator providing group delay interpolation; and
the receive signal decomposition unit includes a commutator configured to receive the digital IF receive I and Q signals and to sample the digital IF I and Q signals.

27. The apparatus as claimed in claim 26, wherein the first and second interpolators are further configured to provide timing adjustments based on a measured frequency error.

28. A method for multicarrier signal modulation, comprising the steps of:
determining a frequency error from an in-phase (I) signal and a quadrature-phase (Q) signal; and
implementing time base adjustments of the I- and Q-signals based on the RF frequency errors.

29. The method as claimed in claim 28, wherein the step of determining includes determining RF frequency errors from the I- and Q-signals.

30. The method as claimed in claim 28, further comprising the step of generating a frequency error ratio, and integrating the frequency error ratio.

31. The method as claimed in claim 30, further comprising the step of interpolating the integrated frequency error ratio.
